(19) United States
(12) Patent Application Publication
(10) Pub. No.: US 2011/0242162 A1
(43) Pub. Date: Oct. 6, 2011

(54) LIQUID EJECTING APPARATUS

(75) Inventor: Noboru TAMURA, Matsumoto-shi (JP)

(73) Assignee: SEIKO EPSON CORPORATION, Tokyo (JP)

(21) Appl. No.: 13/045,096

(22) Filed: Mar. 10, 2011

(30) Foreign Application Priority Data
Mar. 31, 2010 (JP) 2010-080990

(51) Int. Cl. B41J 29/38

(52) U.S. Cl. 347/9

(57) ABSTRACT

A liquid ejecting apparatus having a missing dot detection function capable of performing rapid and accurate missing dot detection with a simple configuration is provided. A liquid ejecting apparatus having a recording head that performs an ejection of ink droplets through nozzle orifices toward a recording sheet includes the recording head having a pair of electrodes electrically disconnected from each other and disposed around the nozzle orifices, wherein the ink droplets have a conductive property; continuity detector that detects the electrodes are electrically connected or disconnected during the ejection; and control means that controls the ejection of the ink droplets by the recording head.

The entire disclosure of Japanese Patent Application No: 2010-080990, filed Mar. 31, 2010 are expressly incorporated by reference herein.

### BACKGROUND

1. Technical Field

The present invention relates to liquid ejecting apparatuses and is particularly useful when applied to liquid ejecting apparatuses that eject electrically conductive liquid, such as metallic ink, mercury and the like.

2. Related Art

Liquid ejecting heads are known that eject liquid droplets through nozzles by means of pressure applied to liquid by pressure generating means such as piezoelectric elements and heat generating elements. Such liquid ejecting heads typically include ink jet recording heads that eject ink droplets through nozzles. For example, JP-A-2005-096419 discloses an ink jet recording head in which a flow channel forming substrate having pressure generating chambers is bonded to a nozzle plate or the like in which nozzle orifices are formed by drilling.

Ink jet recording apparatuses that use this type of ink jet recording head perform detection of a missing dot at a predetermined timing before and after printing in order to maintain a certain level of printing quality. Various techniques for such missing dot detection have been proposed, such as those disclosed in JP-A-2002-210983 and JP-A-2002-178501.

JP-A-2002-210983 discloses a configuration in which the paths of ink droplets ejected through nozzles of a head are each intersected by a laser beam in sequence at a missing dot detection unit. That is, the laser beam is emitted in the horizontal direction such that the laser beam is intersected by the paths of ejected ink droplets which are vertical to the laser beam. In this configuration, when the laser beam is intercepted by the ink droplets, the ink droplets are determined to be properly ejected, while the laser beam is not intercepted by the ink droplets, a missing dot is detected.

JP-A-2002-178501 discloses a missing dot detection unit which is provided with a pyroelectric element and a heat transfer plate and configured such that the heat transfer plate is heated by a heater to a temperature nearly equal to a temperature of a printing head and ink droplets ejected through nozzles land on the heat transfer plate. The pyroelectric element detects a temperature change of the heat transfer plate due to the landing of the ink droplets and transmits output signals to a system controller. The system controller determines whether the ink droplets are properly ejected or not by comparing those output signals with a predetermined threshold value.

However, missing dot detection that uses a laser beam such as that described in JP-A-2002-210983 has a disadvantage in that the device tends to be large and expensive. In addition, there is a problem in that ink jet recording apparatuses do not have enough space for the footprint of the detection unit. Further, missing dot detection that uses heat detection such as that described in JP-A-2002-178501 has a problem in that a long time is required for the detection.

It will be noted the above-mentioned problems exist not only in the ink jet recording heads that eject ink droplets, but also in any liquid ejecting heads that eject liquid droplets other than ink droplets.

### SUMMARY

An advantage of an aspect of the invention is that it provides a liquid ejecting apparatus having a missing dot detection function with a simple configuration capable of performing a rapid and accurate missing dot detection operation.

According to an aspect of the invention, there is provided a liquid ejecting apparatus having a liquid ejecting head that performs an ejection of liquid droplets through nozzle orifices toward an ejection target which includes the liquid ejecting head having a pair of electrodes electrically disconnected from each other and disposed around the nozzle orifices, wherein the liquid droplets have a conductive property, continuity detection means that detects whether the electrodes are electrically connected or disconnected during the ejection of the liquid droplets, and control means that controls the ejection of the liquid droplets by the liquid ejecting head. Accordingly, when the conductive liquid droplets are ejected, the electrodes are electrically short circuited with the liquid droplets forming a part of the electric connection. Therefore, an electrically connected or disconnected state can be associated with ejection or non-ejection state of the liquid droplets. Further, the electrically disconnected state can be associated with an occurrence of a missing dot so as to detect the missing dot.

Further, in the above aspect of the invention, the liquid ejecting head may include a plurality of nozzle orifices and the electrodes are each provided so as to be shared by the plurality of the nozzle orifices. In this case, it is possible to easily and properly specify the nozzle orifice at which a missing dot occurs by ejecting the liquid droplets through each nozzle orifice in a sequential manner. This can be easily achieved when the control means is configured to control the liquid droplets to be ejected in a sequential manner by supplying a drive signal to each of the nozzle orifices in a sequential manner.

Further, in the above aspect of the invention, a liquid ejecting head advantageously includes a plurality of nozzle orifices and one of the electrodes is formed of electrodes that are independently provided for the respective nozzle orifices. In this case, since an electrically connected or disconnected state is detected for each of the respective electrodes, it is possible to detect a missing dot for each of the nozzle orifices independently from other nozzle orifices. Therefore, a predetermined missing dot detection operation can be performed in real time during a predetermined operation such as a printing operation. Here, the control means can perform control such that a single liquid droplet is ejected through each of the respective nozzle orifices. In this case, it is possible to detect a missing dot for all the nozzle orifices with a single ejection of the liquid droplets. That is, a predetermined missing dot detection operation can be performed as quickly as possible.

Further, in the above aspect of the invention, the continuity detection means can transmit a state signal to the control means, the state signal being indicative of an electrically connected or disconnected state, obtained for each of the respective nozzle orifices by detecting in real time whether the electrodes are electrically connected or disconnected during the ejection of the liquid droplets performed by the control means, and the control means may be configured such that the state signal indicative of information on ejection or non-ejection of liquid droplets associated with each of the nozzle orifices of the liquid ejecting head and the state signal indicative of an electrically connected or disconnected state are checked against each other for each nozzle orifice, thereby allowing a missing dot to be detected in real time. In this case, a predetermined missing dot detection operation can be performed in real time during a predetermined operation, thereby enabling an operation to be performed as appropriate after the missing dot is detected.

Further, in the above aspect of the invention, when the missing dot is detected, the control means can control the liquid ejecting head to be transported to a predetermined cleaning area by means of transportation means and perform cleaning of the liquid ejecting head at the cleaning area. In this case, a disadvantage due to the missing dot, such as low quality of printing, can be minimized.

Further, in the above aspect of the invention, when the missing dot is detected, the control means can control a normal nozzle orifice to be placed so as to face the missing dot area on the ejection target and perform the ejection of liquid droplets again to supplement the missing dot. In this case, it is possible to contribute to an improvement in quality by supplementing the low quality of printing due to the missing dot.

### BRIEF DESCRIPTION OF THE DRAWINGS

The invention will be described with reference to the accompanying drawings, wherein like numbers reference like elements.

FIG. 1 is a schematic perspective view of a recording apparatus according to an embodiment of the present invention.

FIG. 2 is an exploded perspective view of a recording head unit according to the embodiment of the present invention.

FIG. 3 is an assembled perspective view of a recording head unit according to the embodiment of the present invention.

FIGS. 4A and 4B are explanation views showing an example of a configuration of a row of nozzle orifices.

FIG. 5 is an explanation view showing another example of a configuration of a row of nozzle orifices.

FIG. 6 is a block diagram showing an example of a control system.

FIG. 7 is a block diagram showing another example of a control system.

FIG. 8 is a circuit diagram showing a specific example of a logic circuit by extracting a part of FIG. 7.

### DESCRIPTION OF EXEMPLARY EMBODIMENTS

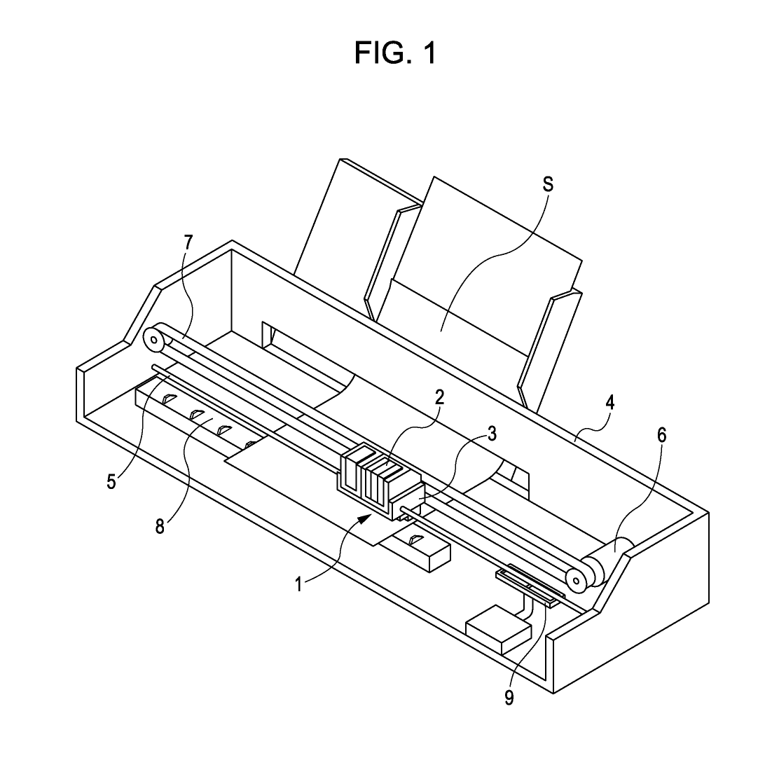

The invention will be described below in detail with reference to an embodiment of the invention. FIG. 1 is a schematic perspective view of an ink jet recording apparatus as an example of a liquid ejecting apparatus according to an embodiment of the invention. FIG. 1 shows an ink jet recording apparatus according to this embodiment which includes an ink jet recording head unit (hereinafter referred to as recording head unit) 1 having an ink jet recording head (hereinafter referred to as recording head). The ink jet recording head unit 1 is provided with an ink cartridge 2 as ink supply means which is removably attached thereto. The recording head unit 1 is mounted on a carriage 3, and the carriage 3 is mounted on a carriage shaft 5 so as to be slidably movable in an axial direction of the carriage shaft 5 that is fixed to the apparatus body 4. When drive power from a drive motor 6 is transmitted to the carriage 3 via a plurality of gears, which are not shown, and a timing belt 7, the carriage 3 along with the recording head unit 1 mounted thereon is moved over the carriage shaft 5. Further, a platen 8 is disposed along the carriage shaft 5 in the apparatus body 4, such that a recording sheet S as an example of a recording medium, such as a sheet of paper, is fed by a feeding roller and the like (not shown) and transported on the platen 8.

Further, at the position which corresponds to the home position of the carriage 3, that is, in proximity of one end of the carriage shaft 5, cap members 9 are disposed which seal the nozzle surfaces of the recording head unit 1 where the nozzles are open. The cap members 9 work to prevent ink in proximity of the nozzles in the recording head unit 1 from being dried by sealing the nozzle surfaces of the recording head unit 1, and also serve as an ink receptacle, for example during a flushing operation for ejecting ink droplets through the nozzles or a suctioning operation performed by suction means to suction ink or the like inside the cap members 9 to purge the nozzles at a predetermined timing.

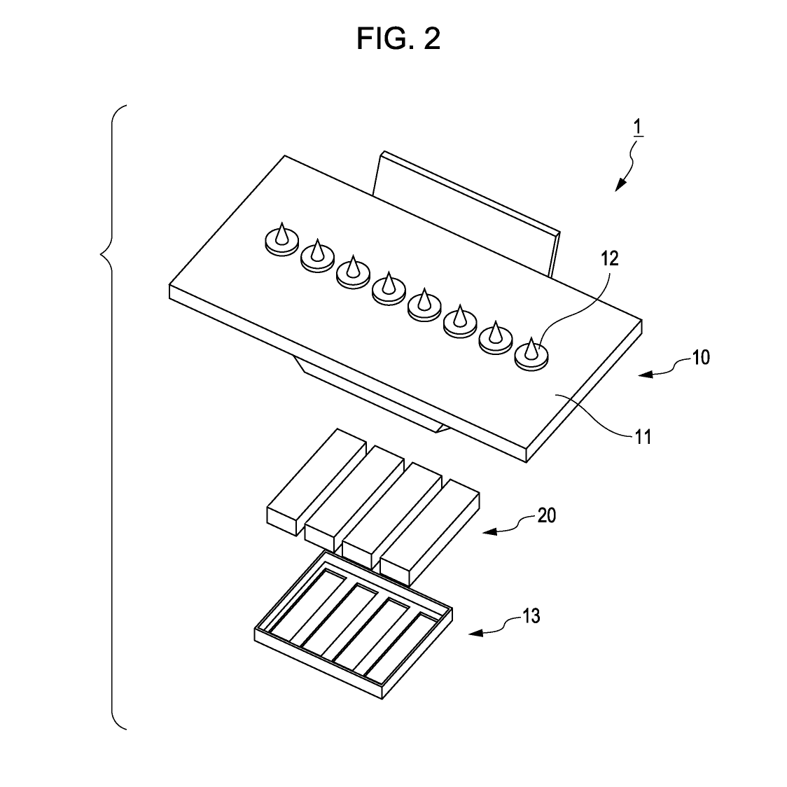

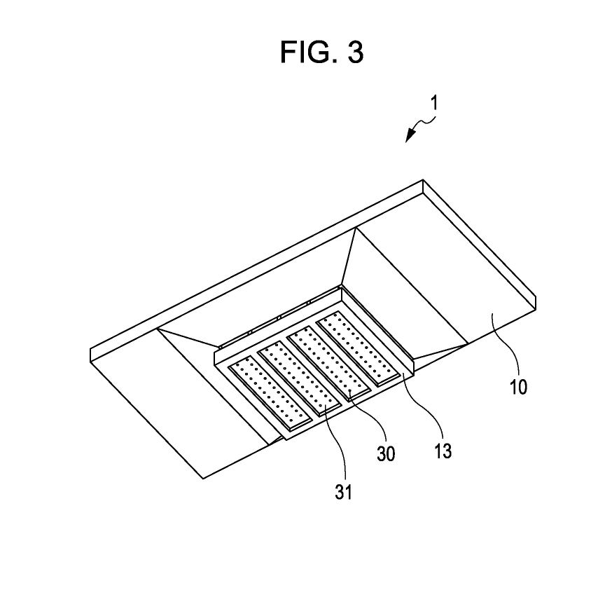

A configuration of the ink jet recording head unit 1 mounted in the ink jet recording apparatus will be described below. FIGS. 2 and 3 are exploded and assembled perspective views, respectively, of an example of the recording head unit 1.

As shown in FIGS. 2 and 3, the recording head unit 1 includes a holder 10, ink jet recording heads (hereinafter referred to as recording heads) 20 as an example of a liquid ejecting head, and a fixation plate to which the nozzle surfaces of the recording heads 20 are bonded so that the recording heads 20 are fixed in position. The nozzle surface is formed of the nozzle plate 31 having a plurality of nozzle orifices 30 through which ink droplets are ejected. The nozzle orifices 30 are arranged to form specific nozzle rows. It should be noted that the ink ejected from the recording head 20 needs to be electrically conductive, such as metallic ink, because missing dot detection is performed using conductive properties of the ink, as will be described later in detail.

The holder head 10 has a cartridge mounting member 11 which is made of an insulative material such as a resin, such that each ink cartridge (not shown) is mounted on the cartridge mounting member 11. Further, ink supply needles 12, which are adapted to be inserted into the ink cartridges, are fixed on the cartridge mounting member 11. The ink supply needles 12 communicate with ink introduction paths through which ink is supplied to the respective recording heads 20.

A plurality of (four, in this embodiment) recording heads 20 are positioned spaced apart from each other at predetermined intervals and fixed to the bottom of the holder head 10. The recording heads 20 are provided so that each of them corresponds to a color of ink, and bonded to the fixation plate 13, thereby being positioned relative to each other and secured on the bottom of the holder head 10.

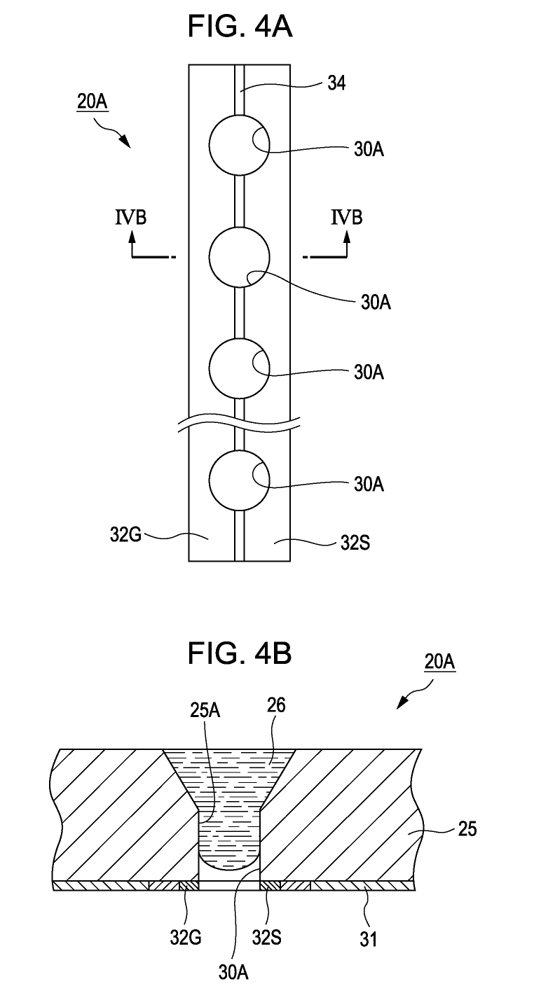

FIG. 4A is a plan view showing an example of a configuration of nozzle orifices of the recording head mounted in the ink jet recording apparatus of this embodiment. FIG. 4B is a sectional view taken along the line IVB-IVB of FIG. 4A. As shown in FIGS. 4A and 4B, a recording head 20A according to this embodiment has nozzle rows, each of which is composed of a plurality of nozzle orifices 30A. A pair of electrodes 32S and 32G, which are electrically isolated from each other, is disposed around the respective nozzle orifices 30A. In this embodiment, the electrodes 32S and 32G are provided so as to be shared by all the nozzle orifices 30A and electrically isolated by an insulating material 34 disposed between the electrodes 32S and 32G. More specifically, the electrodes 32S and 32G are embedded in the recesses formed by countersinking around the respective nozzle orifices 30A in the nozzle plate 31 so as to be flush with the surface of the nozzle plate 31, as shown in FIG. 4B. The nozzle plate 31 is bonded to the underside of the flow channel forming substrate 25, which communicates with pressure chambers (not shown), such that, a conductive ink 26 is ejected and introduced through the communication holes 25A to the nozzle orifices 30A when a pressure generated in the pressure chambers is applied to the conductive ink 26. Normally, that is, when ink is not ejected, the conductive ink 26 has its meniscus formed above the electrodes 32S and 32G so that the meniscus is not brought into contact with the electrodes 32S and 32G.

Accordingly, in this embodiment, when the conductive ink 26 is ejected, the electrodes 32S and 32G are short circuited through the conductive ink 26. Such a short circuit can be electrically detected, and thus the ejection of the ink 26 through the nozzle orifices 30A can be detected. In spite of a pressure being generated in the pressure generating chambers by drive signals sent to the recording head 20A, if no ink droplets have been detected as have been ejected through the corresponding nozzle orifice 30A, that is, no short circuit between the electrode 32S and 32G has been detected, this means a missing dot occurs at the corresponding nozzle orifice 30A.

In this embodiment, the ink 26 needs to be electrically conductive, because the missing dot detection operation is performed using the ink 26 ejected through the nozzle orifices 30A as part of the electrical path.

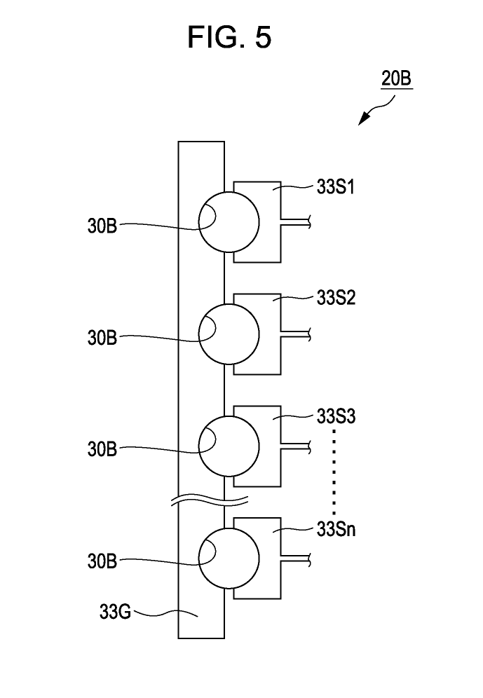

FIG. 5 is a plan view showing another example of the nozzle orifices 30A, which is different from the example described above. As shown in FIG. 5, the recording head 20B according to this embodiment has electrodes, one of which is an electrode 33G that is formed so as to be shared by all the nozzle orifices 30B, and that is similar to that illustrated in FIG. 4. On the other hand, the other electrodes 33S1, 33S2, 33S3, . . . 33Sn are independently disposed for the respective nozzle orifices 30B so as to oppose the electrode 33G.

Thus, in this embodiment, a short circuit between the electrode 33G and one of the electrodes from 33S1 to 33Sn can be detected for each of the nozzle orifices 30B. That is, the ejection of the conductive ink 26 can be detected for each of the nozzle orifices 30B.

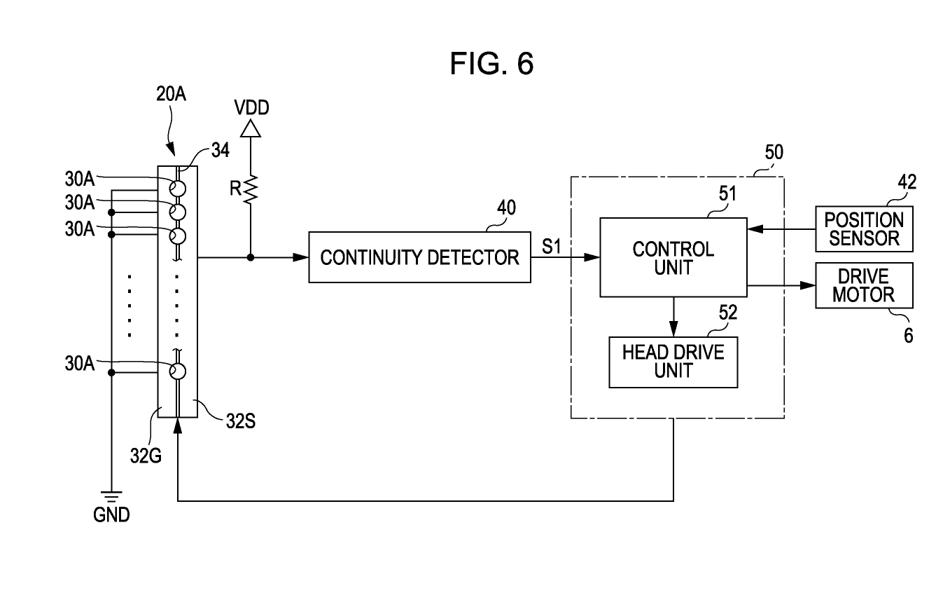

FIG. 6 is a block diagram of an example of a control system having a missing dot detection function according to the embodiment. This example corresponds to FIG. 4 in which the recording head 20A is used. As shown in FIG. 6, the electrode 32S of the recording head 20A is connected to a power supply potential VDD via a resistor R, that is, pulled up to the positive side, while the electrode 32G is connected to the ground potential GND.

Accordingly, when the electrodes 32S and 32G that correspond to one of the nozzle orifices 30A are short circuited through the conductive ink 26, the continuity detector 40 detects that the electrode 32S is at a GND potential. On the other hand, when a short circuit is not created between the electrodes 32S and 32G, the continuity detector 40 detects that the electrode 32S is at a power supply potential VDD. Those two states are each associated with 0 and 1 of binary signals. That is, the continuity detector 40 detects whether the electrodes 32S and 32G are in an electrically connected or disconnected state, and transmits an output signal indicative of the state as a binary state signal S1 to control means 50.

In this embodiment, control means 50 is provided with a control unit 51 and a head drive unit 52. The control unit 51 performs ejection control of ink ejected through the nozzle orifices 30A via the head drive unit 52. The control unit 51 stores ejection command information specifies which of the nozzle orifices 30A has received an ejection command. In this embodiment, the control unit 51 compares the ejection command information and the state signal S1, thereby specifying a nozzle orifice 30A at which a missing dot has occurred. That is, during detection of a missing dot, the control unit 51 supplies the drive signals to each of the nozzle orifices 30A via the head drive unit 52 in a sequential manner so that ink droplets are ejected through the nozzle orifices 30A in a sequential manner.

Accordingly, state signals S1 of 0 or 1 can be obtained for each of the nozzle orifices 30A. As a result, the nozzle orifices 30A at which a missing dot has occurred, that is, the nozzle orifices 30A of the state signal 1, can be specified.

Further, the control unit 51 controls the movement of the carriage 3 by controlling the activation of the drive motor 6 (see FIG. 1) in response to the output signals from the position sensor 42 that detects the position of the carriage 3 (see FIG. 1) on the carriage shaft 5 (see FIG. 1).

Accordingly, in this embodiment, missing dot detection can be performed for each of the nozzle orifices 30A by detecting whether the electrodes 32S and 32G are in an electrically connected or disconnected state during the ejection of the conductive ink 26.

In response to such information on a missing dot, the control unit 51 can perform various controls. For example, when a missing dot is detected, cleaning of the recording head 20A may be performed. In this case, the carriage 3 is moved to the cap member 9 (see FIG. 1) that is disposed at the home position, in accordance with the output signals from the position sensor 42. At the home position, a flushing operation for ejecting ink droplets through the nozzle orifices 30A or a suctioning operation by the suction means for suctioning ink or the like inside the cap member 9 to purge the nozzle orifices 30A at a predetermined timing can be performed.

The missing dot detection as described above is desirably performed after the carriage 3 has been moved to the home position where the cap member (see FIG. 1) is located, and the nozzle surface has been sealed with the cap member 9. This is because ink can be collected by the cap member 9 even after having been ejected through the nozzle orifices. Note that the missing dot detection is desirably performed with ink being ejected as little as possible in order to reduce the amount of waste ink. This can be achieved by adjusting the ejection pressure such that ink will flow upwardly without being ejected after it reaches the nozzle orifice 30A and works to form a short circuit between the electrodes 32S and 32G.

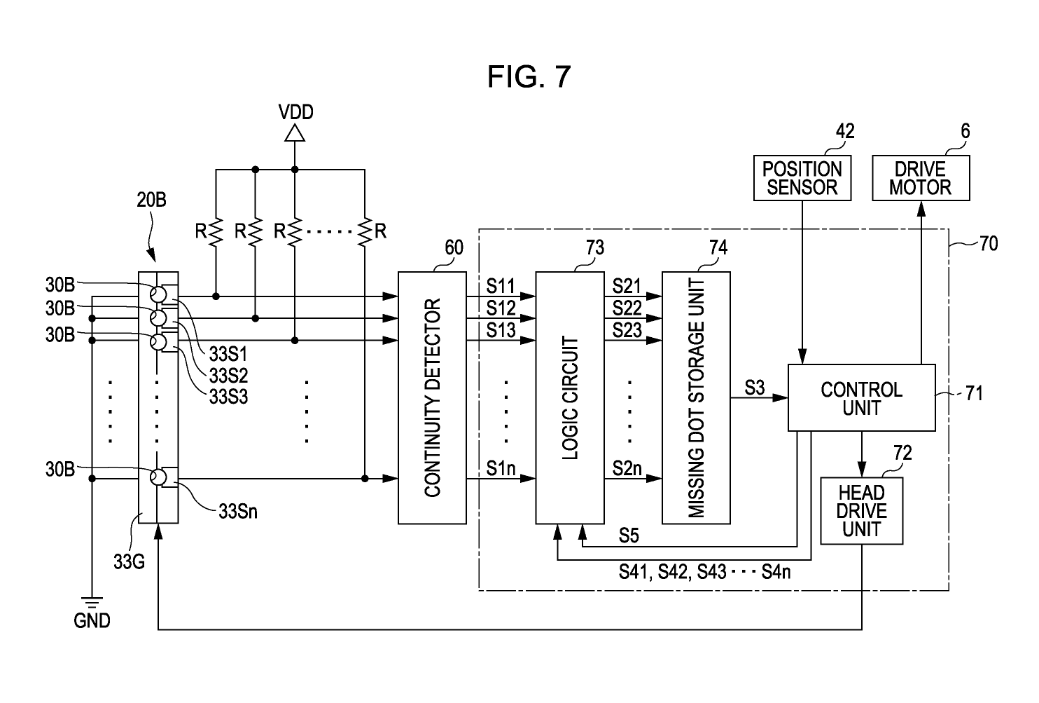

FIG. 7 is a block diagram of another example of a control system having a missing dot detection function according to the embodiment. This example corresponds to FIG. 5 in which the recording head 20B is used. As shown in FIG. 7, the electrodes 33S1 to 33Sn of the recording head 20B are each connected to a power supply potential VDD via a resistor R, that is, pulled up to the positive side, while the electrode 33G is connected to the ground potential GND.

Accordingly, when the electrodes 33S1 to 33Sn and 33G are short circuited through the conductive ink 26, the continuity detector 60 detects that the electrodes 33S1 to 33Sn are at a GND potential. On the other hand, when a short circuit is not created between the electrodes, the continuity detector 60 detects that the electrodes 33S1 to 33Sn are at a power supply potential VDD. Those two states are each associated with 0 and 1 of binary signals. That is, the continuity detector 60 detects whether the electrodes 33S1 to 33Sn and 33G are in an electrically connected or disconnected state and transmits output signals indicative of the state as binary state signals S11, S12, S13, . . . S1n to a logic circuit 73.

The logic circuit 73 is configured such that state signals S41, S42, S43, . . . S4n indicative of information on ejection or non ejection of ink droplets, associated with each of the nozzle orifices 30B of the recording head 20B and state signals S11, S12, S13, . . . S1n indicative of electrical connection or disconnection are verified with each other for each of the nozzle orifices 30B, thereby enabling a missing dot can be detected. The missing dot detection according to this embodiment can be performed in real time. Here, the state signals S41 to S4n are associated with 0 when in an ejection state of ink droplets and associated with 1 when in a non-ejection state.

Further, regardless of ejection or non-ejection of ink droplets, the state signal S5 which is set to 1 is also transmitted from the control unit 71 to the logic circuit 73, the reason of which will be described later.

Based on a predetermined logic processing of the logic circuit 73, the missing dot signals S21, S22, S23, . . . Sn are generated in a sequential manner for the electrodes 33S1 to 33Sn at which a dot missing has been detected and stored in a missing dot storage unit 74. Here, information to specify the electrodes 33S1 to 33Sn at which a missing dot occurs is also stored.

The control unit 71 performs a predetermined control in response to a missing dot signal S3, which had been stored in a missing dot storage unit 74 with information to specify the nozzle orifice 30B at which a missing dot occurs. The details of the control are described later.

In this embodiment, since the electrodes 33S1 to 33Sn are independently provided, even when ink droplets are ejected through all the nozzle orifices 30B at a time, a missing dot can be independently detected at the corresponding nozzle orifice 30B by detecting the electrodes 33S1 to 33Sn and the electrode 33G which are electrically disconnected. Such missing dot detection can be performed in real time during a specific printing operation in the ink jet recording apparatus.

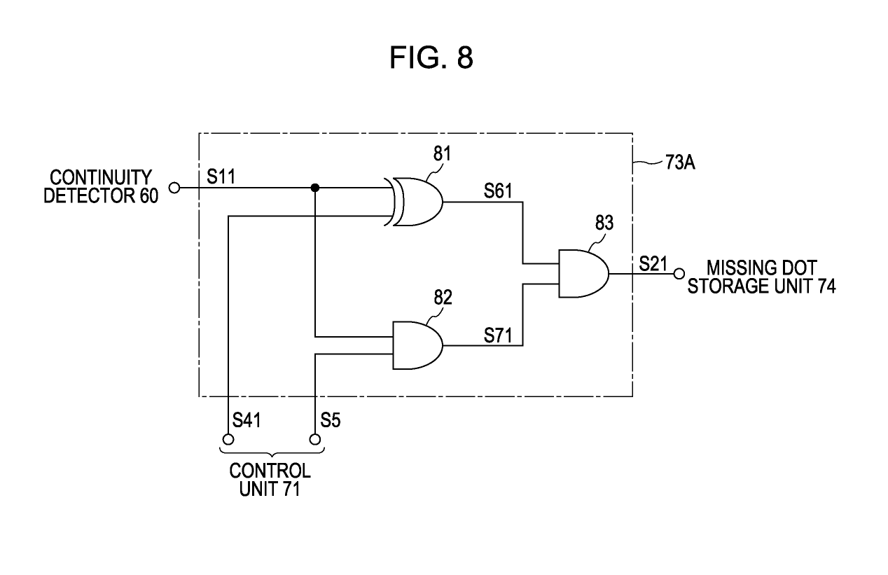

The logic processing in the logic circuit 73 will be further specifically described. FIG. 8 is a circuit diagram showing a specific example of a logic circuit, which is extracted from the circuit diagram of FIG. 7 by extracting a part of FIG. 7. As shown in FIG. 7, this logic circuit is for detecting a missing dot based on the state signal S11 which is output with respect to the electrode 33S1. In the logic circuit 73, similar logic circuits are each provided for the corresponding electrodes 33S1 to 33Sn.

As shown in FIG. 8, this logic circuit is composed of an Ex-OR circuit 81 and two AND circuits 82 and 83. The Ex-OR circuit 81 outputs the Ex-OR logic of the state signal S11 and the state signal S41. The AND circuit 82 outputs the AND logic of the state signal S11 and the state signal S5. The AND circuit 83 outputs the AND logic of the output signal S61 of the Ex-OR circuit 81 and the output signal S71 of the AND circuit 82. Here, the state signal S11 is represented as either 0 or 1, where 0 indicates the electrode 33S1 and the electrode S33G are electrically connected, while 1 indicates the electrode 33S1 and the electrode S33G are electrically disconnected. The state signal S41 is represented as either 0 or 1, where 0 indicates that the nozzle orifice 30B which corresponds to the electrode 33S1 is in ejection state in which ink droplets are to be ejected, while 1 indicates that the nozzle orifice 30B which corresponds to the electrode 33S1 is in non-ejection state in which ink droplets are not to be ejected. The state signal S5 is constantly set to 1.

Accordingly, there are four combinations of the relationship between the input and output signals of the Ex-OR circuit 81, the AND circuit 82 and the AND circuit 83. Tables 1 to 3 show those combinations as states 1, 2, 3 and 4. In the tables, state 1 indicates that the electrode 33S1 is electrically connected (0) and the corresponding nozzle orifice 30B is in ejection state (0). Similarly, state 2 indicates that the electrode 33S1 is electrically disconnected (1) and the corresponding nozzle orifice 30B is in ejection state (0). State 3 indicates that the electrode 33S1 is electrically connected (0) and the corresponding nozzle orifice 30B is in non-ejection state (1). State 4 indicates that the electrode 33S1 is electrically disconnected (1) and the corresponding nozzle orifice 30B is in non-ejection state (1).

TABLE 1
Ex-OR circuit 81

| State | 1 | 2 | 3 | 4 |
|---|---|---|---|---|
| S11 | 0 | 1 | 0 | 1 |
| S41 | 0 | 0 | 1 | 1 |
| S61 | 0 | 1 | 1 | 0 |

TABLE 2
AND circuit 82

| State | 1 | 2 | 3 | 4 |
|---|---|---|---|---|
| S11 | 0 | 1 | 0 | 1 |
| S5 | 1 | 1 | 1 | 1 |
| S71 | 0 | 1 | 0 | 1 |

TABLE 3
AND circuit 83

| State | 1 | 2 | 3 | 4 |
|---|---|---|---|---|
| S61 | 0 | 1 | 1 | 0 |
| S71 | 0 | 1 | 0 | 1 |
| S21 | 0 | 1 | 0 | 0 |

As is obvious from the above tables 1 to 3, a missing dot occurs at state 2. Therefore, only in the case of state 2, the output signal from the AND circuit 83 needs to be 1 indicative of a missing dot. States 1 and 4 indicate a normal operation. State 3 indicates that the electrode 33S1 and the electrode 33G are electrically connected in spite of non-ejection state in which ink droplets are not ejected. This is an abnormal state, however it does not indicate a missing dot which is intended to be detected here. Therefore, the output signal 1 in state 3 of the Ex-OR circuit 81 is further processed with a predetermined AND logic in the AND circuits 82 and 83 so that the output signal in state 3 is not generated as 1.

In the control unit 71 of this embodiment, various control operations can be performed. Although not limited to a specific control operation, the following described ejection controls can be performed.

The control unit 71 controls the nozzle orifices 30B via the head drive unit 72 so that ink droplets are ejected through the nozzle orifices 30B. This enables a detection of a missing dot for all the nozzle orifices 30B with a single ejection of the liquid droplets as described above.

When a missing dot is detected during an operation such as printing, the control unit 71 determines the operation as abnormal and suspends the operation. Alternatively, it completes a predetermined process, and after the completion of the operation, performs the cleaning of the recording head 20B. The control of cleaning can be advantageously performed in a similar manner as described above.

When a missing dot is detected, information that specifies the nozzle orifices 30B where the missing dot is detected is also stored. Therefore, in the path (scan) after the missing dot is detected, the control unit 71 moves the recording head 20B to supplement the missing dot area and adds the further paths. That is, the control unit 71 allows a normal nozzle orifice 30B to be moved so as to face the missing dot area and perform the ejection of liquid droplets again via the nozzle orifices 30B which is known to properly work.

The invention has been described with reference to embodiments, however the invention is not limited to those embodiments. Although the invention has been described in the above embodiments by means of an example of ink jet recording apparatus that ejects ink droplets, the invention is intended to broadly cover liquid ejecting apparatuses having liquid ejecting heads in general. Such liquid ejecting heads include, for example, recording heads used for image recording apparatuses such as printers, color material ejecting heads used for manufacturing color filters for liquid crystal displays and the like, electrode material ejecting heads used for forming electrodes for organic electroluminescence displays, field emission displays (FEDs) and the like, and bioorganic ejection heads used for manufacturing biochips. Further, the invention is also useful for liquid ejecting apparatuses in which mercury is ejected to the ejection target so as to form a textured surface taking advantage of the large mass of mercury.

What is claimed is:

1. A liquid ejecting apparatus having a liquid ejecting head that performs an ejection of liquid droplets through nozzle orifices toward an ejection target, comprising:
the liquid ejecting head having a pair of electrodes electrically disconnected from each other and disposed around the nozzle orifices, wherein the liquid droplets have a conductive property;
continuity detection means that detects whether the electrodes are electrically connected or disconnected during the ejection of the liquid droplets; and
control means that controls the ejection of the liquid droplets by the liquid ejecting head.

2. The liquid ejecting apparatus according to claim 1, wherein the liquid ejecting head includes a plurality of nozzle orifices and the electrodes are each provided so as to be shared by the plurality of the nozzle orifices.

3. The liquid ejecting apparatus according to claim 2, wherein the control means controls the liquid droplets to be ejected in a sequential manner by supplying a drive signal to each of the nozzle orifices in a sequential manner.

4. The liquid ejecting apparatus according to claim 1, wherein the liquid ejecting head includes a plurality of nozzle orifices and one of the electrodes is formed of electrodes that are independently provided for the respective nozzle orifices.

5. The liquid ejecting apparatus according to claim 4, wherein the control means performs control such that a single liquid droplet is ejected through each of the respective nozzle orifices.

6. The liquid ejecting apparatus according to claim 4, wherein the continuity detection means transmits a state signal to the control means, the state signal being indicative of an electrically connected or disconnected state, obtained for each of the respective nozzle orifices by detecting in real time whether the electrodes are electrically connected or disconnected during the ejection of the liquid droplets performed by the control means, and the control means is configured such that the state signal indicative of information on ejection or non-ejection of liquid droplets associated with each of the nozzle orifices of the liquid ejecting head and the state signal indicative of an electrically connected or disconnected state are checked against each other for each nozzle orifice, thereby allowing a missing dot to be detected in real time.

7. The liquid ejecting apparatus according to claim 6, wherein, when the missing dot is detected, the control means controls the liquid ejecting head to be transported to a predetermined cleaning area by means of transportation means and perform cleaning of the liquid ejecting head at the cleaning area.

8. The liquid ejecting apparatus according to claim 6, wherein, when the missing dot is detected, the control means controls a normal nozzle orifice to be placed so as to face the missing dot area on the ejection target and perform the ejection of liquid droplets again to supplement the missing dot.
